(19) United States
(12) Patent Application Publication
(10) Pub. No.: US 2006/0267946 A1
(43) Pub. Date: Nov. 30, 2006

(54) Methods and systems for providing feedback corresponding to user input

(75) Inventors: David Brian Wecker, Redmond, WA (US); Otto Gabriel Berkes, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/136,869

(22) Filed: May 25, 2005

(51) Int. Cl. G09G 5/00

(52) U.S. Cl. 345/168

(57) ABSTRACT

Systems and methods are disclosed for providing feedback corresponding to user input. The disclosed systems and methods may include receiving input from a user manipulatable input device, the input corresponding at least one of the following: symbols and commands. Furthermore, the disclosed systems and methods may include overlaying on a display device a virtual image representative of the user manipulatable input device. In addition, the disclosed systems and methods may include provisioning the virtual image to indicate a user's interaction with the user manipulatable input device.

### BACKGROUND OF THE INVENTION

I. Field of the Invention

The present invention generally relates to methods and systems for providing feedback. More particularly, the present invention relates to providing feedback corresponding to user input.

II. Background Information

Electronic devices such as computers, cellular telephones, and personal digital assistants, for example, are becoming commonplace. Furthermore, these devices are being manufactured in smaller and smaller packages. In some situations, the packages are so small that it becomes difficult to provide a user input device, such as a keyboard, for the electronic device. To provide these small electronic devices with a user input device, some are configured with a “laser keyboard”. In this case, the electronic device may project a full-size “virtual” keyboard on a desk or other flat surface using lasers. One laser in the device projects the keyboard image, while the other laser senses the touched projected keys. This conventional approach, however, provides an inaccurate virtual keyboard having no tactile feedback.

Another conventional approach may comprise provisioning the electronic device with a portable wireless keyboard using, for example, bluetooth. In this case, the user may need to maintain and transport two devices, the electronic device and the wireless keyboard.

Thus, the conventional strategy is to provide an inaccurate non-tactile virtual keyboard or require the transportation and maintenance of a separate wireless keyboard. This often causes problems because the conventional strategy does not provide a keyboard on the computing device while also providing the user with feedback relative to the keyboard's use. In view of the foregoing, there is a need for methods and systems for providing feedback more optimally. Furthermore, there is a need for providing feedback corresponding to user input.

### SUMMARY OF THE INVENTION

Consistent with embodiments of the present invention, systems and methods are disclosed for providing feedback corresponding to user input.

In accordance with one embodiment, a method for providing feedback corresponding to user input comprises receiving input from a user manipulatable input device, the input corresponding at least one of the following: symbols and commands, overlaying on a display device a virtual image representative of the user manipulatable input device, and provisioning the virtual image to indicate a user's interaction with the user manipulatable input device.

According to another embodiment, a system for providing feedback corresponding to user input comprises a memory storage for maintaining a database and a processing unit coupled to the memory storage, wherein the processing unit is operative to receive input from a user manipulatable input device, the input corresponding at least one of the following: symbols and commands, overlay on a display device a virtual image representative of the user manipulatable input device, and provision the virtual image to indicate a user's interaction with the user manipulatable input device.

In accordance with yet another embodiment, a computer-readable medium which stores a set of instructions which when executed performs a method for providing feedback corresponding to user input, the method executed by the set of instructions comprising receiving input from a user manipulatable input device, the input corresponding at least one of the following: symbols and commands, overlaying on a display device a virtual image representative of the user manipulatable input device, and provisioning the virtual image to indicate a user's interaction with the user manipulatable input device.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram of an exemplary feedback providing system consistent with an embodiment of the present invention;

FIG. 2 is a flow chart of an exemplary method for providing feedback corresponding to user input consistent with an embodiment of the present invention;

FIG. 3 is a diagram illustrating a display consistent with an embodiment of the present invention; and

FIG. 4 is a diagram illustrating the back of a computing device consistent with an embodiment of the present invention; and

FIG. 5 is a diagram illustrating a virtual image overlaid on a display device consistent with an embodiment of the present invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering, or adding stages to the disclosed methods. Accordingly, the following detailed description does not limit the invention. Instead, the proper scope of the invention is defined by the appended claims.

Systems and methods consistent with embodiments of the present invention provide feedback corresponding to user input. For example, embodiments of the invention may display visual feedback graphics of a user's finger position relative to a fixed keyboard layout. The display may be on an electronic device's front and the keyboard may be on the electronic device's back (e.g. a side of the electronic device facing away from the user.) The display may provide a virtual image of the keyboard's layout that may be on the back side of the device. The display may also provide a virtual image of a user's finger's position using, for example, a non-destructive graphics layer displayed over other graphic information on the display. The feedback graphics may allow the user to continue to see and interact with the other graphic information on the display. The system may also allow the user to perceive that the user can see through the device to be able to position the user's fingers in order to accurately target specific keys on the keyboard.

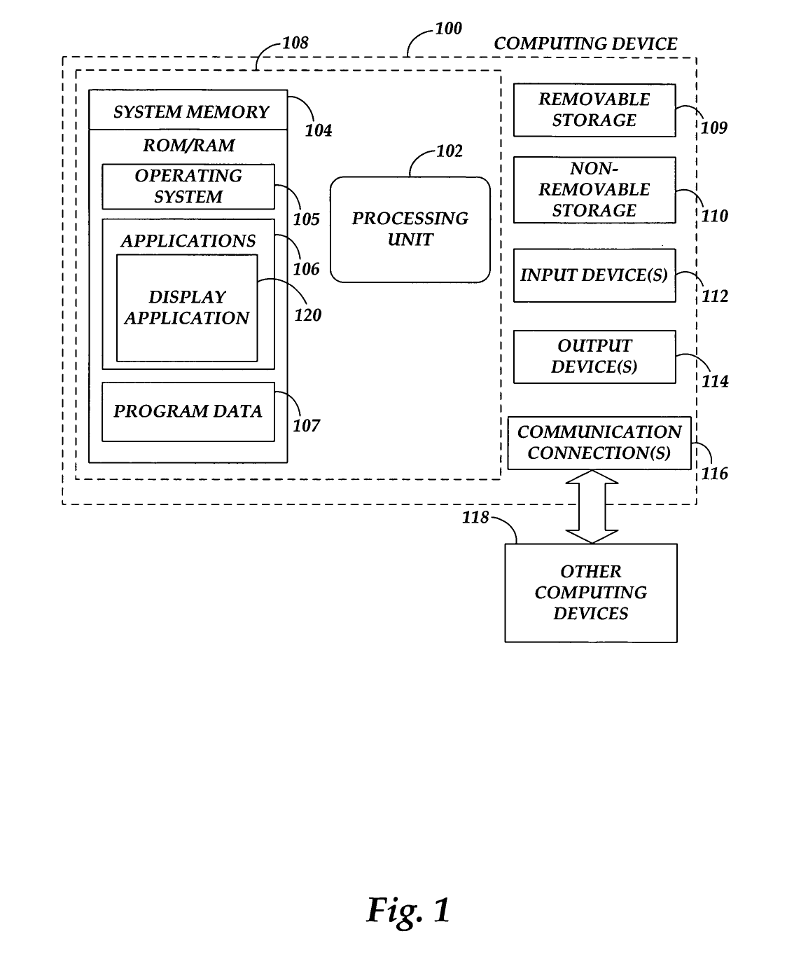

Referring now to the drawings, in which like numerals refer to like elements through the several figures, aspects of the present invention and an exemplary operating environment will be described. FIG. 1 and the following discussion are intended to provide a brief, general description of a suitable computing environment in which embodiments of the invention may be implemented. While embodiments of the invention may be described in the general context of program modules that execute in conjunction with an application program that runs on an operating system on a personal computer, embodiments of the invention may also be implemented in combination with other program modules.

An embodiment consistent with the invention may comprise a system for providing feedback corresponding to user input. The system may comprise a memory storage for maintaining a database and a processing unit coupled to the memory storage. The processing unit may be operative to receive input from a user manipulatable input device, the input corresponding at least one of symbols and commands. Furthermore, the processing unit may be operative to overlay on a display device a virtual image representative of the user manipulatable input device. In addition, the processing unit may be operative to provision the virtual image to indicate a user's interaction with the user manipulatable input device.

Consistent with an embodiment of the present invention, the aforementioned memory, processing unit, and other components may be implemented in a computing device, such as an exemplary computing device 100 of FIG. 1. Any suitable combination of hardware, software, and/or firmware may be used to implement the memory, processing unit, or other components. By way of example, the memory, processing unit, or other components may be implemented with any of computing device 100 or any of other computing devices 118, in combination with computing device 100. The aforementioned system, device, and processors are exemplary and other systems, devices, and processors may comprise the aforementioned memory, processing unit, or other components, consistent with embodiments of the present invention.

Generally, program modules may include routines, programs, components, data structures, and other types of structures that perform particular tasks or implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

With reference to FIG. 1, one exemplary system consistent with an embodiment of the invention may include a computing device, such as computing device 100. In a basic configuration, computing device 100 may include at least one processing unit 102 and a system memory 104. Depending on the configuration and type of computing device, system memory 104 may be volatile (such as RAM), non-volatile (such as ROM, flash memory, etc.) or some combination. System memory 104 may include an operating system 105, one or more applications 106, and may include a program data 107. In one embodiment, application 106 may include a display application 120. This basic configuration is illustrated in FIG. 1 by those components within a dashed line 108.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by a removable storage 109 and a non-removable storage 110. Computer storage media may include volatile and nonvolatile, removable and non-removable media implemented in any method or technology for storage of information, such as computer readable instructions, data structures, program modules, or other data. System memory 104, removable storage 109, and non-removable storage 110 are all examples of computer storage media. Computer storage media may include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included. The aforementioned devices are exemplary and others may be used.

Computing device 100 may also contain a communication connection 116 that may allow device 100 to communicate with other computing devices 118, such as over a network in a distributed computing environment, for example, an intranet or the Internet. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. The term computer readable media as used herein may include both storage media and communication media.

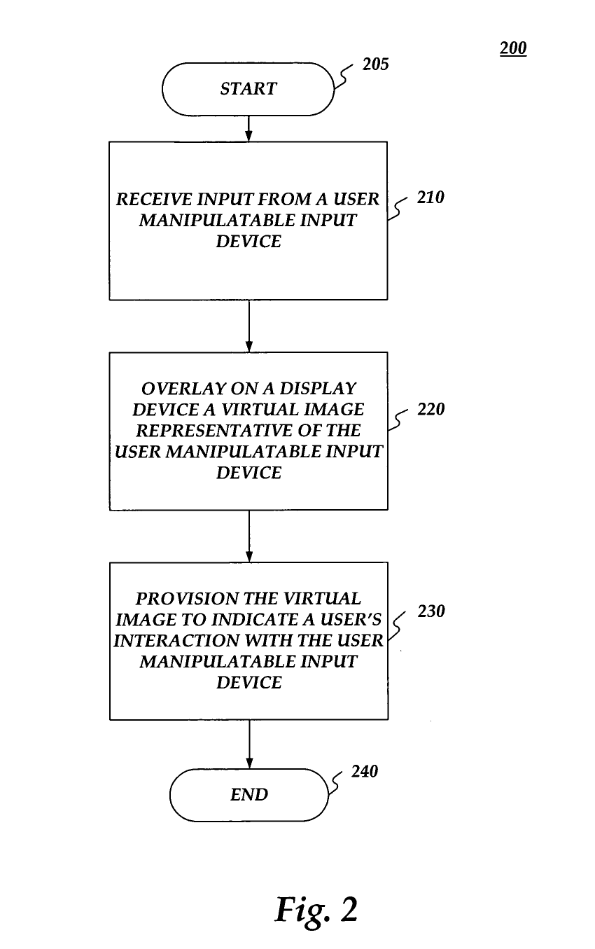

A number of program modules and data files may be stored in system memory 104 of computing device 100, including an operating system 105 suitable for controlling the operation of a networked personal computer, such as the WINDOWS operating systems from MICROSOFT CORPORATION of Redmond, Wash. System memory 104 may also store one or more program modules, such as display application 120, and others described below. While executing on processing unit 102, display application 120 may perform processes for providing feedback corresponding to user input, including, for example, one or more of the stages of method 200 described below with respect to FIG. 2. The aforementioned process is exemplary, and processing unit 102 may perform other processes. Other applications 106 that may be used in accordance with embodiments of the present invention may include electronic mail and contacts applications, word processing applications, spreadsheet applications, database applications, slide presentation applications, drawing or computer-aided application programs, etc.

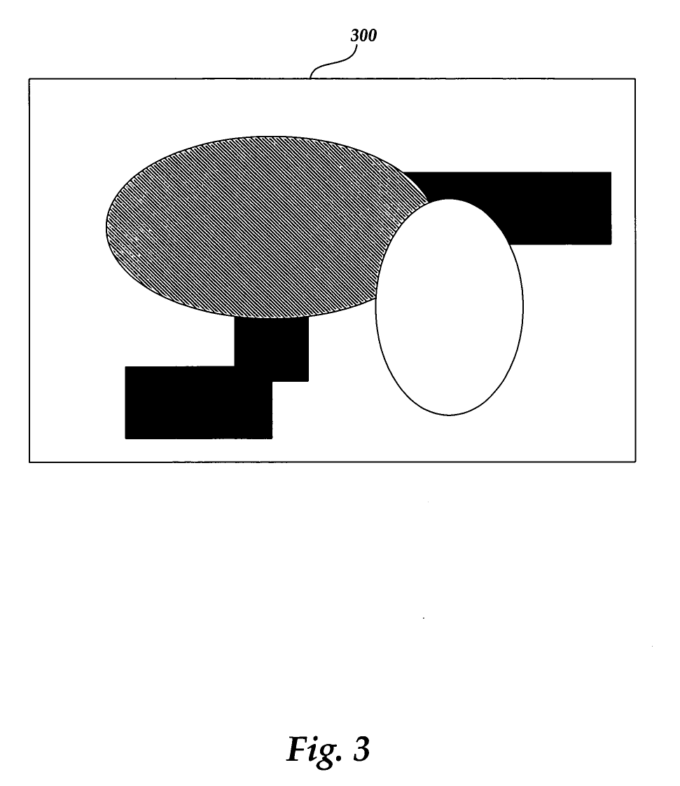

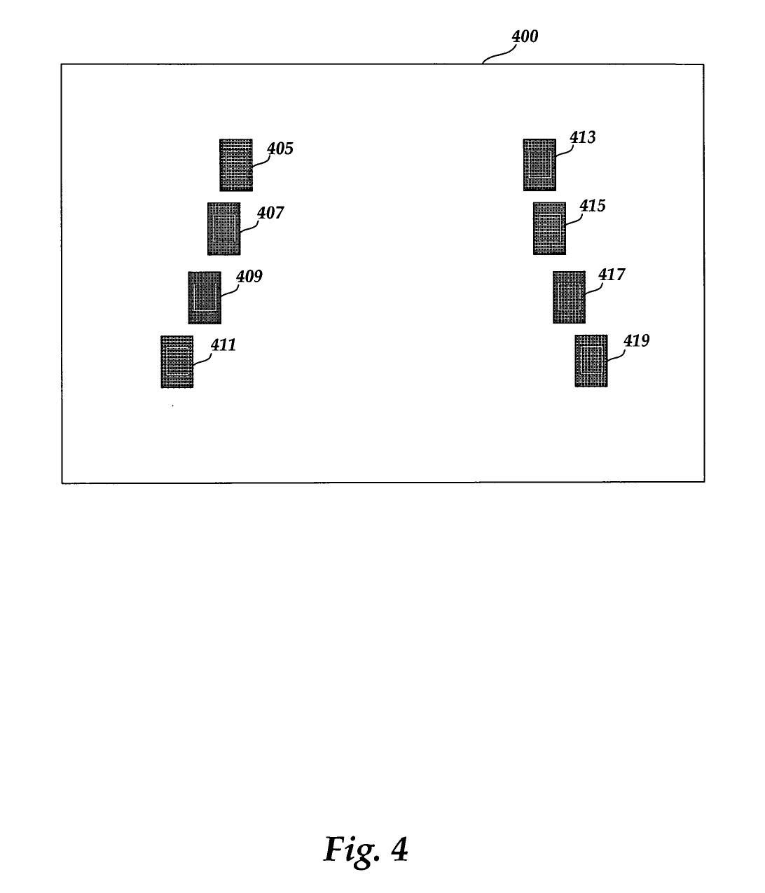

FIG. 2 is a flow chart setting forth the general stages involved in an exemplary method 200 consistent with the invention for providing feedback corresponding to user input using system 100 of FIG. 1. Exemplary ways to implement the stages of exemplary method 200 will be described in greater detail below. Exemplary method 200 may begin at starting block 205 and proceed to stage 210 where computing device 100 may receive input from a user manipulatable input device, for example, input device 112. For example, FIG. 3 shows a display on computing device 100. FIG. 4 shows, for example, a backside of computing device 100. For example, the user manipulatable input device may comprise a capacitive keyboard 400 that may be constructed on the backside of computing device 100. Accordingly, computing device 100 may be provisioned with a keyboard that may not be directly visually perceivable by the user while the user is viewing a display on the front side of computing device 100. The aforementioned is exemplary, and the user manipulatable input device may comprise other types of devices, capacitive or otherwise.

As shown in FIG. 4, capacitive keyboard 400 may include nubs 405 through 419. These nubs may correspond, for example, to a “home row” of keyboard 400. For example, nubs 405, 407, 409, and 411 may respectively correspond to the “f”, “d”, “s”, and “a” keys, while nubs 413, 415, 417, and 419, may correspond to the “j”, “k”, “l”, and “;” keys. Capacitive keyboard 400 may include other keys corresponding to other positions on the back of computing device 100, however, these keys may not be visually apparent. Nubs 405 through 419 may provide a tactile feedback, thus providing the user with the home row keys positions and relative positions of other keys relative to the home row. Notwithstanding, other keys (not having corresponding nubs, for example), may be marked (e.g. via silkscreen) on the backside of computing device 100. Moreover, the user may manipulate a finger, for example, on capacitive keyboard 400 and cause the combination of the finger and capacitive keyboard 400 to have the functionality, for example, of a mouse. The user may manipulate a finger in a plurality of gestures corresponding to, for example, scroll, cut, copy, and paste.

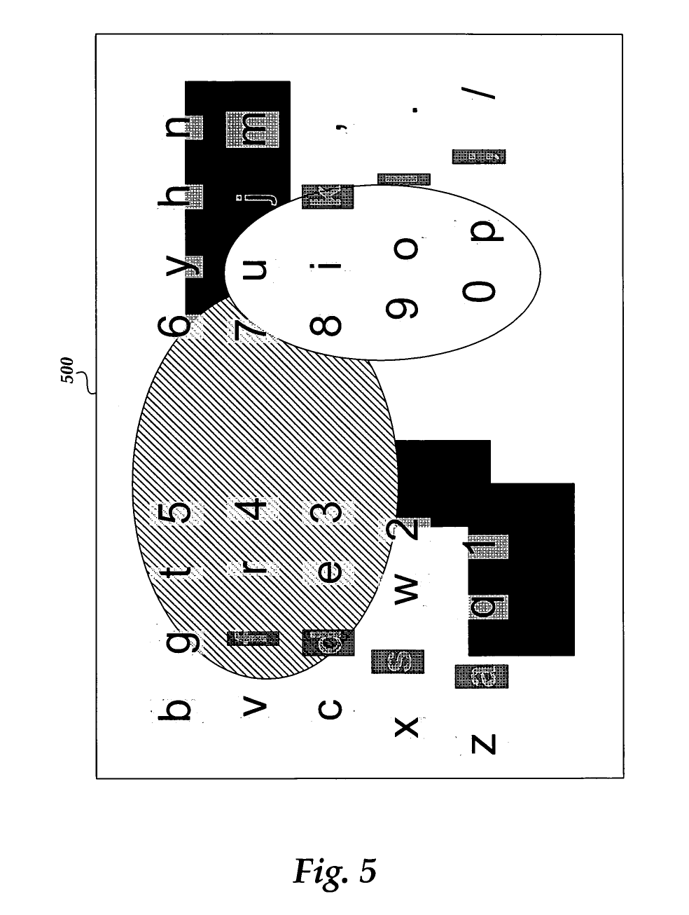

From stage 210, where computing device 100 may receive input from the user manipulatable input device, exemplary method 200 may advance to stage 220 where computing device 100 may overlay on a display device 500 a virtual image representative of the user manipulatable input device. For example, FIG. 5 shows a virtual image of capacitive keyboard 400 overlaid on display device 500 included with computing device 100. The virtual image may be overlaid on another graphic image, such as the image shown in FIG. 3. The virtual image may be semi-transparent, allowing, for example, the other graphic image of FIG. 3 to be also seen by the user. The virtual image may appear when the user touches capacitive keyboard 400 and disappear when the user no longer touches capacitive keyboard 400.

Once computing device 100 overlays on display device 500 the virtual image representative of the user manipulatable input device in stage 220, exemplary method 200 may continue to stage 230 where computing device 100 may provision the virtual image to indicate a user's interaction with the user manipulatable input device. For example, when a user's finger “hovers” over a particular key, the virtual image may highlight the corresponding key image in the virtual image as shown in FIG. 5. For example, FIG. 5 shows the home row keys highlighted. This may be because the user's fingers are hovering on the keyboard 400's home row. In other words, the virtual image may highlight a key image when the user's finger hovers over the corresponding key. If the user presses harder, for example (i.e. harder than hovering, for example), this key stroke may be entered similar to striking a standard keyboard.

Using the virtual image, the user may obtain visual feedback as to where the user's fingers are on keyboard 400. In this way, the user may know where the user's fingers are on keyboard 400 without directly viewing keyboard 400. The user may not be able to directly view keyboard 400, because keyboard 400 may be on a side of computing device 100 positioned away from the user's eyes. By knowing where the user's fingers are from the virtual image, the user may type on keyboard 400 and provide input to computing device 100. Moreover, the virtual image may be used as a training device and computing device may be configured to no longer overlay the virtual image after the user learns the key positions on keyboard 400. After computing device 100 provisions the virtual image to indicate the user's interaction with the user manipulatable input device in stage 230, exemplary method 200 may then end at stage 240.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The present invention may be embodied as systems, methods, and/or computer program products. Accordingly, the present invention may be embodied in hardware and/or in software (including firmware, resident software, micro-code, etc.). Furthermore, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention are described above with reference to block diagrams and/or operational illustrations of methods, systems, and computer program products according to embodiments of the invention. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

While certain features and embodiments of the invention have been described, other embodiments of the invention may exist. Furthermore, although embodiments of the present invention have been described as being associated with data stored in memory and other storage mediums, aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

What is claimed is:

1. A method for providing feedback corresponding to user input, the method comprising:
receiving input from a user manipulatable input device, the input corresponding at least one of the following: symbols and commands;
overlaying on a display device a virtual image representative of the user manipulatable input device; and
provisioning the virtual image to indicate a user's interaction with the user manipulatable input device.

2. The method of claim 1, wherein receiving input from the user manipulatable input device further comprises receiving input from the user manipulatable input device representative of a keyboard.

3. The method of claim 2, wherein receiving input from the user manipulatable input device representative of the keyboard further comprises receiving input from the user manipulatable input device representative of the keyboard wherein the user manipulatable input device includes at least one of the following: at least one nub associated with at least one key position associated with the user manipulatable input device and at least one visually perceivable indicia indicating at least one key position associated with the user manipulatable input device.

4. The method of claim 1, wherein receiving input from the user manipulatable input device further comprises receiving input from the user manipulatable input device not visually perceivable by the user.

5. The method of claim 1, wherein overlaying on the display device the virtual image representative of the user manipulatable input device further comprises overlaying on the display device the virtual image representative of the user manipulatable input device when the user interacts with the user manipulatable input device.

6. The method of claim 1, wherein overlaying on the display device the virtual image representative of the user manipulatable input device further comprises:
overlaying on the display device the virtual image representative of the user manipulatable input device when the user interacts with the user manipulatable input device; and
hiding the virtual image representative of the user manipulatable input device when the user ceases interaction with the user manipulatable input device.

7. The method of claim 1, wherein provisioning the virtual image to indicate the user's interaction with the user manipulatable input device further comprises provisioning the virtual image to indicate the user's interaction with the user manipulatable input device wherein the virtual image indicates an amount of physical pressure the user exerts on a specific area of the user manipulatable input device.

8. A system for providing feedback corresponding to user input, the system comprising:
a memory storage for maintaining a database; and
a processing unit coupled to the memory storage, wherein the processing unit is operative to
receive input from a user manipulatable input device, the input corresponding at least one of the following: symbols and commands;
overlay on a display device a virtual image representative of the user manipulatable input device; and
provision the virtual image to indicate a user's interaction with the user manipulatable input device.

9. The system of claim 8, wherein the processing unit being operative to receive input from the user manipulatable input device further comprises the processing unit being operative to receive input from the user manipulatable input device representative of a keyboard.

10. The system of claim 9, wherein the processing unit being operative to receive input from the user manipulatable input device representative of the keyboard further comprises the processing unit being operative to receive input from the user manipulatable input device representative of the keyboard wherein the user manipulatable input device includes at least one of the following: at least one nub associated with at least one key position associated with the user manipulatable input device and at least one visually perceivable indicia indicating at least one key position associated with the user manipulatable input device.

11. The system of claim 8, wherein the processing unit being operative to receive input from the user manipulatable input device further comprises the processing unit being operative to receive input from the user manipulatable input device not visually perceivable by the user.

12. The system of claim 8, wherein the processing unit being operative to overlay on the display device the virtual image representative of the user manipulatable input device further comprises the processing unit being operative to overlay on the display device the virtual image representative of the user manipulatable input device when the user interacts with the user manipulatable input device.

13. The system of claim 8, wherein the processing unit being operative to overlay on the display device the virtual image representative of the user manipulatable input device further comprises the processing unit being operative to:
overlay on the display device the virtual image representative of the user manipulatable input device when the user interacts with the user manipulatable input device; and
hide the virtual image representative of the user manipulatable input device when the user ceases interaction with the user manipulatable input device.

14. The system of claim 8, wherein the processing unit being operative to provision the virtual image to indicate the user's interaction with the user manipulatable input device further comprises the processing unit being operative to provision the virtual image to indicate the user's interaction with the user manipulatable input device wherein the virtual image indicates an amount of physical pressure the user exerts on a specific area of the user manipulatable input device.

15. A computer-readable medium which stores a set of instructions which when executed performs a method for providing feedback corresponding to user input, the method executed by the set of instructions comprising:
receiving input from a user manipulatable input device, the input corresponding at least one of the following: symbols and commands;
overlaying on a display device a virtual image representative of the user manipulatable input device; and
provisioning the virtual image to indicate a user's interaction with the user manipulatable input device.

16. The computer-readable medium of claim 15, wherein receiving input from the user manipulatable input device further comprises receiving input from the user manipulatable input device representative of a keyboard.

17. The computer-readable medium of claim 16, wherein receiving input from the user manipulatable input device representative of the keyboard further comprises receiving input from the user manipulatable input device representative of the keyboard wherein the user manipulatable input device includes at least one of the following: at least one nub associated with at least one key position associated with the user manipulatable input device and at least one visually perceivable indicia indicating at least one key position associated with the user manipulatable input device.

18. The computer-readable medium of claim 15, wherein overlaying on the display device the virtual image representative of the user manipulatable input device further comprises overlaying on the display device the virtual image representative of the user manipulatable input device when the user interacts with the user manipulatable input device.

19. The computer-readable medium of claim 15, wherein overlaying on the display device the virtual image representative of the user manipulatable input device further comprises:
overlaying on the display device the virtual image representative of the user manipulatable input device when the user interacts with the user manipulatable input device; and
hiding the virtual image representative of the user manipulatable input device when the user ceases interaction with the user manipulatable input device.

20. The computer-readable medium of claim 15, wherein provisioning the virtual image to indicate the user's interaction with the user manipulatable input device further comprises provisioning the virtual image to indicate the user's interaction with the user manipulatable input device wherein the virtual image indicates an amount of physical pressure the user exerts on a specific area of the user manipulatable input device.
